(19) United States
(12) Patent Application Publication
(10) Pub. No.: US 2014/0267698 A1
(43) Pub. Date: Sep. 18, 2014

(54) METHOD AND SYSTEM FOR INTERACTIVE MOBILE ROOM DESIGN

(71) Applicant: Daniel Rivas, Rego Park, NY (US)

(72) Inventor: Daniel Rivas, Rego Park, NY (US)

(21) Appl. No.: 14/208,638

(22) Filed: Mar. 13, 2014

Related U.S. Application Data
(60) Provisional application No. 61/785,502, filed on Mar. 14, 2013.

(51) Int. Cl. H04N 5/232

(52) U.S. Cl. CPC H04N 5/23293
USPC 348/135; 348/61

(57) ABSTRACT

A method for room design includes photographing a room with a camera to generate a digital photograph. One or more objects are digitally cleared from the digital photograph to generate a digitally cleared photograph. A wire frame outline of an object is drawn in the digitally cleared photograph. A viewfinder of the camera is opened with the wire frame outline superimposed in the viewfinder. A new object substantially conforming to the dimensions of the wire frame outline is photographed. The method includes populating the digitally cleared photograph with the new object.

### CROSS-REFERENCE TO RELATED APPLICATION

This application claims priority from U.S. Provisional Patent Application No. 61/785,502, filed Mar. 14, 2013, the entire contents of which are incorporated by reference herein.

### TECHNICAL FIELD

The present disclosure relates to a method and system for digitally photographing, clearing and interactively designing and furnishing residential and commercial rooms or spaces through the use of wire frame outlines and populating furniture and other items or products into interactively designed spaces.

### DESCRIPTION OF RELATED ART

The ubiquitous presence of Smartphones, laptops and tablet computers with high resolution cameras, sophisticated mobile applications and near-constant Internet connectivity has created a powerful tool that can be put to use across a multitude of disciplines. Simultaneously, in the field of interior design online commerce has created nearly limitless and constant availability and access to a multitude of furnishings, materials and other products. However, there does not currently exist a simple and user friendly tool for capturing an image of a room or other space and allowing a user to seamlessly visualize dimensions where furnishings, materials and other products can be populated to digitally design a room in an interactive format. Existing products require users to conceptualize advanced spatial orientations and visualize complex dimensions which are not easily resolved by a non-expert designer. A simplified and user-friendly interactive design tool is needed which harnesses the power of mobile computing while still being practically useful to a non-expert designer.

### SUMMARY

An object of the method and system described herein is to create a user friendly interface to design and furnish rooms and other areas of residential and commercial spaces. The method and system described herein may allow users to seamlessly document desired furnishing, décor and other objects that can be stored for later use and manipulation and ultimately utilized to make purchases of desired products through associated portals and systems.

The method and system all users to photograph spaces using a digital camera (e.g. cameras associated with a Smartphone or Tablet computer), clear the space through finger or stylus navigation, sketch in wire frame outlines for the rough dimensions of furniture, décor and other objects, calling up the drawn fire frames in a subsequent use of a digital cameras viewfinder, photographing desired products and interactively populating, designing and saving rooms for later use.

The method and system allows users to save, price and ultimately purchase desired products corresponding to the wire frames.

The method and system disclosed herein may operate through interactive features contained on mobile devices or Web based applications and Internet/server based web sites.

### BRIEF DESCRIPTION OF THE DRAWINGS

Various illustrative embodiments of the present invention are described herein with reference to the drawings, wherein:

FIG. 1 is a flow chart outlining exemplary steps of the invention allowing a user to photograph a design space, populate the space by clearing the room using wire frames and ultimately allowing a user to save and purchase desired products.

FIG. 2 is a user's viewpoint representation of an embodiment of the present invention as they relate to a Smartphone or tablet computer where a wire frame outline has been called up in the camera viewfinder such that a user can photograph objects, products, furniture, etc. that correspond with the wire frame outline and save the images for later manipulation and use in populating or designing a cleared out room or design space.

FIG. 3 is a computer system for implementing a method according to an exemplary embodiment of the present invention.

### DETAILED DESCRIPTION

FIG. 1 is a flow chart outlining exemplary steps of the invention allowing a user to photograph a design space, populate the space by clearing the room using wire frames and ultimately allowing a user to save and purchase desired products.

Referring to FIG. 1, Step 201 illustrates that a user can use a camera, such as a digital camera (e.g. one associated with a Smartphone, cellular/mobile telephone or tablet computer) to photograph and store an image of a residential, commercial or other room or desired design space and save a digital image of the space for later manipulation, population, furnishing and design.

Referring to FIG. 1, Step, 201 may allow a user to modify color schemes, architectural elements, dimensions, elevations, windows, doors, and other associated attributes to further design a realistic space.

Referring to FIG. 1, Step 202 illustrates that a user can take a furnished space that has been digitally photographed and remove individual objects from the room, either one at a time or in groups of varying sizes, to ultimately clear out the room for the placement of new design elements.

Referring to FIG. 1, Step 202, it is anticipated that a user can remove all objects from a design space leaving completely blank walls and floors or can further remove only a single object, or some combination of objects or furnishings. This function is dynamic and can be done in steps where a digital image of a partially cleared room is saved, some objects populated and later removed, or original objects that were not initially cleared can be later removed by the user and the updated image saved for later retrieval and manipulation.

Referring to FIG. 1, Step 203 illustrates that a user can draw in fire frame outlines that correspond with individual items, products, furniture, windows, doors, pictures, frames, architectural elements or any other objects or products which could fit within a design space. Such wire frames can be individually saved and retrieved for later use both within a camera viewfinder or singly or in groups within the cleared out design space.

Referring to FIG. 1, Step 203, it is anticipated that approximate dimensions could be manually entered or automatically calculated by the disclosed systems or methods to increase the accuracy of wire frames and their correspondence with real world objects, furnishings or products.

Referring to FIG. 1, Step 204 illustrates that a user can open a camera viewfinder with a wire frame superimposed within the viewfinder to photograph new objects, furnishings or products that fit within the wire frame.

Referring to FIG. 1, Step 205 illustrates that newly captured digital images of products fitting completely or approximately within a wire frame can be saved and retrieved for later manipulation, interactive placement and general use in designing and populating the design space.

Referring to FIG. 1, Step 206 a design space can be populated with objects, designed for color schemes, furnishings and architectural elements. This design process can utilize previously saved images that correspond with wire frames, new images stored or retrieved from the Internet or newly conceived objects can be sketched into the design space using finger navigation or a stylus.

Referring to FIG. 1, Step 207 illustrates that the system may facilitate a user purchasing any object or product associated with the design space. It is anticipated that the system may further facilitate keeping track of pricing, sales, overall budget and the amount of funds needed to complete a design space project. Objects or products can be added or removed with associated pricing considered to reach a desired budget or find a more cost effective product.

Referring to FIG. 1, Steps 301 and 302 illustrate that any step in procedure 100 can be saved for later retrieval and each step can be individually iterated multiple times both in and out of sequence, saved and retrieved for later use by the user.

FIG. 2 is a user's viewpoint representation of an embodiment of the present invention as they relate to a Smartphone or tablet computer where a wire frame outline has been called up in the camera viewfinder such that a user can photograph objects, products, furniture, etc. that correspond with the wire frame outline and save the images for later manipulation and use in populating or designing a cleared out room or design space.

Referring to FIG. 2, embodiment 200 illustrates a user's view of a sketched wire frame that has been called up into a digital camera viewfinder and is being used to photograph an object of corresponding sizes/dimensions.

Referring, generally, to FIG. 2, the wire frame shown within the camera's viewfinder can be further manipulated at this point or left in a static position within the viewfinder. The angle of the wire frame can be adjusted and approximate or actual dimensions of the wire frame or objects within the camera's viewfinder can be either manually entered or automatically generated by the disclosed systems and methods.

It is further anticipated that the disclosed systems and methods will allow a user viewing a desired object or product through the camera viewfinder to scan and identify objects within the viewfinder, such that the dimensions of the actual product can be automatically identified and populated into the viewfinder view in order to allow the user to see that actual size and dimensions of the objet or product.

It is anticipated that the disclosed systems and methods will be highly flexible and dynamic and that each individual step, process and feature of the system and method will focus on practical and user friendly completion of a customized design space that can easily be re-created in the real world using actual objects and products that have been identified, saved, located and or purchased on the Internet or elsewhere and applied to the user's design space.

More particularly, referring to FIG. 3, according to an exemplary embodiment of the present invention, a computer system 501 for mobile room design can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 stored in memory 503 (e.g., a non-transitory computer-readable storage medium) and executed by the CPU 502 to process the signal from the signal source 508. As such, the computer system 501 is a general-purpose computer system that becomes a specific purpose computer system when executing the routine 507 of the present invention.

The computer platform 501 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

From the foregoing and with reference to the figure drawing, those skilled in the art will appreciate that certain modifications can also be made to the present disclosure without departing from the scope of the same. Therefore, the above description should not be construed as limiting, but merely as exemplifications of particular embodiments.

What is claimed is:

1. A method of room design, comprising:
photographing a room with a camera to generate a digital photograph;
digitally clearing one or more objects from the digital photograph to generate a digitally cleared photograph;
drawing a wire frame outline of an object in the digitally cleared photograph;
opening a viewfinder of the camera with the wire frame outline superimposed in the viewfinder;
photographing a new object substantially conforming to the dimensions of the wire frame outline; and
populating the digitally cleared photograph with the new object and thereby designing a room.

2. The method of room design of claim 1, wherein the camera is a digital camera of a Smartphone or tablet computer.

3. The method of room design of claim 1, wherein the room is in a residential space.

4. The method of room design of claim 1, wherein the room is in a commercial space.

5. The method of room design of claim 1, wherein the object is furniture.

6. The method of room design of claim 1, wherein the object is artwork or a sculpture.

7. The method of room design of claim 1, wherein identifying information for purchase of the photographed new object is automatically detected and saved.

8. The method of room design of claim 7, wherein the identifying information is detected by scanning a barcode of the new object.

9. The method of room design of claim 1, wherein the wire frame is drawn using a stylus.

10. The method of room design of claim 1, wherein the digitally cleared photograph is digitally manipulated before populating the digitally cleared photograph with the new object.

11. The method of room design of claim 1, wherein the superimposed wire frame outline is manually manipulated within the viewfinder of the camera.

12. The method of room design of claim 1, wherein the angle of the superimposed wire frame outline within the viewfinder of the camera is automatically adjusted to correspond with an object falling substantially within the wire frame outline.

13. The method of room design of claim 1, wherein more than one wire frame outline is superimposed in the viewfinder of the camera simultaneously.

14. The method of room design of claim 1, wherein dimensions of the object falling within the wire frame outline superimposed in the viewfinder of the camera are automatically detected and displayed within the camera viewfinder.

15. The method of room design of claim 14, wherein identifying information for purchase of the objects is automatically saved.
